(19) United States
(12) Patent Application Publication
(10) Pub. No.: US 2017/0103095 A1
(43) Pub. Date: Apr. 13, 2017

(54) System of third party event selection for personal calendars

(71) Applicant: Janine C.Y. HSU, Chatswood (AU)

(72) Inventor: Janine C.Y. HSU, Chatswood (AU)

(21) Appl. No.: 15/287,774

(22) Filed: Oct. 7, 2016

(30) Foreign Application Priority Data
Oct. 7, 2015 (AU) 2015904085

(51) Int. Cl. G06F 17/30

(52) U.S. Cl. CPC G06F 17/30336; G06F 17/30876

(57) ABSTRACT

A combinatory device; said combinatory device having at least a processor, a memory, a GPS module and a wireless communications module all in electronic communication with each other within the combinatory device; a software module executable on the combinatory device; the software module receiving data from at least a first data store; said data store having at least a first processor, a memory and a first data store communications module; the first datastore storing at least first indexed data; said first indexed data referenced against at least a first criterion and a second criterion; the software module receiving data from at least a second datastore; said second datastore having at least a processor, a memory and a second datastore communications module; the second datastore storing at least second indexed data; said second indexed data referenced against at least a first criterion and a second criterion. Also disclosed is a method of combining content retrieved from an internet connected computer network; the method comprising of storing fixed form content and variable form content in a first database; storing fixed form content and variable form content in at least a second database remote from the first database; indexing the variable form content by the use of keys; transmitting the variable form content and the fixed form content to a combinatory device; selecting content derived from the variable form content for presentation referenced against a time scale based on criteria.

### BACKGROUND

The integration of third party events into a person's personal calendar is a popular requirement, as people like to organise their lives so as to plan and have reminders of important events as they come up. Typically, events are promoted, advertised and shared, by mediums such as email or social networks, as well as general media where major events are publicised.

A common problem is that the integration of these events and the decision making process that involves prioritisation of what a person will do with their time, is typically handled in a manual fashion. For example, if a person is visiting a particular city during a certain time period, and they investigate what events or other opportunities are available in that particular city that they may wish to include in their calendar, the person must search the Internet or other sources of media information and then manually integrate these events into their calendar.

Systems such as Microsoft Outlook's ability to be able to share calendar events are useful for sharing events between specific people. However this functionality is typically limited to individuals and is not compiled in a database where multiple events can be compiled, filtered and then used as a basis for planning and selection by the user.

Problem: currently users of different diary/scheduling software need to access multiple different platforms to locate relevant data at best using multiple different applications to do it.

The core problem is: how do we bring the data on all the platforms together so as to be viewable and controllable by means of a single application?

Solution: collect and input the data to a single application on a single platform using a combinatory device which has the ability to “login” to and/or assimilate from multiple other platforms seamlessly.

Embodiments of the described invention are designed to address these limitations and issues.

### BRIEF DESCRIPTION OF INVENTION

The core problem is: how do we bring the data on all the platforms together so as to be viewable and controllable by means of a single application? Particularly thereby opening up the opportunity for further control and on—export.

Solution: collect and input the data to a single application on a single platform using a combinatory device which, in one form, has the ability to “login” to and/or assimilate from multiple other platforms seamlessly.

Accordingly, in one broad form of the invention, there is provided a combinatory device; said combinatory device having at least a processor, a memory, a GPS module and a wireless communications module all in electronic communication with each other within the combinatory device; a software module executable on the combinatory device; the software module receiving data from at least a first data store; said data store having at least a first processor, a memory and a first data store communications module; the first datastore storing at least first indexed data; said first indexed data referenced against at least a first criterion and a second criterion; the software module receiving data from at least a second datastore; said second datastore having at least a processor, a memory and a second datastore communications module; the second datastore storing at least second indexed data; said second indexed data referenced against at least a first criterion and a second criterion.

Accordingly, in a further broad form of the invention, there is provided a software module for receiving a data feed from multiple sources; said software module executable on a combinatory device; said combinatory device having at least a processor, a memory, a GPS module and a wireless communications module all in electronic communication with each other within the combinatory device; the software module receiving data from at least a first data store; said data store having at least a first processor, a memory and a first data store communications module; the first datastore storing at least first indexed data; said first indexed data referenced against at least a first criterion and a second criterion; the software module receiving data from at least a second datastore; said second datastore having at least a processor, a memory and a second datastore communications module; the second datastore storing at least second indexed data; said second indexed data referenced against at least a first criterion and a second criterion.

Accordingly, in a further broad form of the invention, there is provided an operating system executable on a combinatory device; the operating system providing access to an application running within the operating system environment; access including access to GPS data; incoming wireless data and a controlled access network account capability which is enabled by account aware network access requests.

Accordingly, in a further broad form of the invention, there is provided a content combining system for combining content retrieved from an Internet computer network; a local client on a combinatory device generating network access requests for individual controlled access network accounts; at least one combining scheme; the combining scheme allowing network access requests via an operating system whereby controlled access accounts may be given selected access to one or more datastores located remotely.

Accordingly, in a further broad form of the invention, there is provided a relational database for storing data used to populate form records fields wherein a database table structure stores both fixed and variable form content for multiple form types by creating tables to store the fixed form content and variable form content; and wherein the database structure permits the fixed form content to be updated to create a new version of a specific form and generate version specific variable form content for each form type in the database; and wherein the fixed form content and variable form content is stored in a relational database and wherein keys are stored and used to link data between forms; and wherein the keys are generated by an application executing on a platform on a combinatory device; the application in communication with at least indexed data stored in a first datastore and second indexed data stored in a second datastore; the combinatory device located remote from the first datastore and the second datastore; and wherein communication between the application and the first datastore and the second datastore is via the Internet.

In yet a further broad form of the invention there is provided a processor including a relational database for storing data used to populate form records fields wherein a database table structure stores both fixed and variable form content for multiple form types by creating tables to store the fixed form content and variable form content; and wherein the database structure permits the fixed form content to be updated to create a new version of a specific form and generate version specific variable form content for each form type in the database; and wherein the fixed form content and variable form content is stored in a relational database and wherein keys are stored and used to link data between forms; and wherein the keys are generated by an application executing on a platform on a combinatory device; the application in communication with at least indexed data stored in a first datastore and second indexed data stored in a second datastore; the combinatory device located remote from the first datastore and the second datastore; and wherein communication between the application and the first datastore and the second datastore is via the Internet.

In a further broad form of the invention there is provided a user interface whereby data sourced from multiple data feeds is indexed and populated against a time scale.

In yet a further broad form of the invention there is provided a method of combining content retrieved from an internet connected computer network; the method comprising of storing fixed form content and variable form content in a first database; storing fixed form content and variable form content in at least a second database remote from the first database; indexing the variable form content by the use of keys; transmitting the variable form content and the fixed form content to a combinatory device; selecting content derived from the variable form content for presentation referenced against a time scale based on criteria.

Preferably content is selected from the variable form content based on the keys.

Preferably selection is determined with reference to previous patterns of use of a user.

Preferably patterns of use of a user are used to determine which criteria are used for selection of variable form content.

### DRAWINGS

FIG. 1—Main components of the example embodiment.

FIG. 2—Example user interface of the example embodiment.

FIG. 3—Example of filtration opportunities for prioritisation and selection of events of interest to the user.

FIG. 4—is an electronic block diagram of an implementation of an embodiment of the system.

FIG. 5 is an electronic block diagram of an implementation of a further embodiment of the system incorporating export functionality to a second digital device.

### DESCRIPTION AND OPERATION

The core problem is: how do we bring the data on all the platforms together so as to be viewable and controllable by means of a single application?

Solution: collect and input the data to a single application on a single platform using a combinatory device which, in one form, has the ability to “login” to and/or assimilate from multiple other platforms seamlessly.

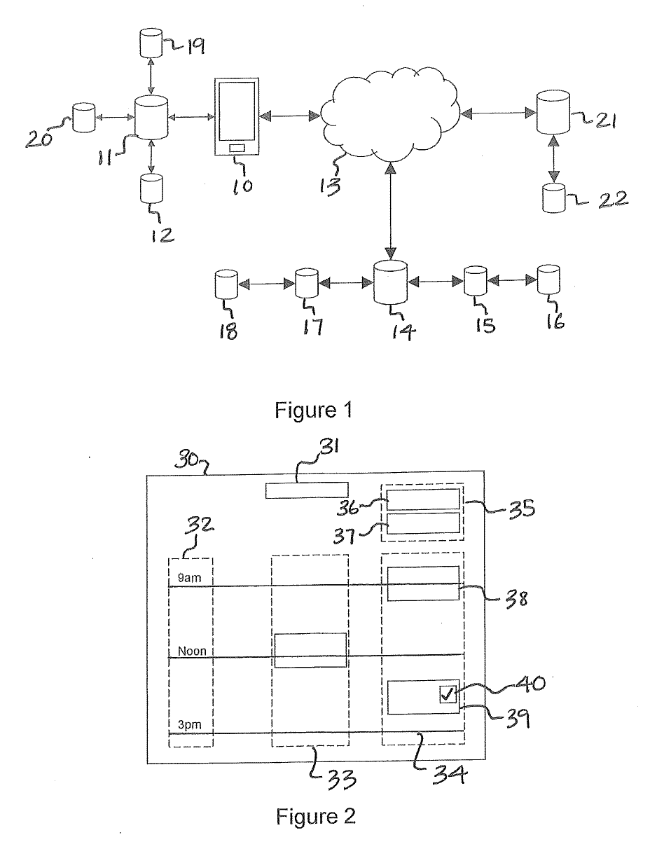

FIG. 1 discloses the main components of an example embodiment. Typically, a user's device 10 contains a calendar application 11 that may contain within it personal events 12 that the user has entered manually to remember certain events of importance to them. The example embodiment has this calendar application 11 connected via a public network such as the Internet 13 to an event compiling server 14 which has the purpose of compiling events and places of interest from multiple event publishers 21 who are publishing event information 22 for specific times, periods, locations.

The event compiling server 14 includes a database of users where each user has a listing of events 16 that they wish to select and include in their personal calendar 11 and combined with their personal events 12.

The event compiling server 14 also includes a database of event publishers 21 who independently provide event information 22 and publish it to the event compiling server 14. Each event publisher 17 is linked to a listing of the events published by that publisher 18. A user 10 is given access to the event compiling server 14 so that events can be presented to them using filtered settings 19 where the user can view what events are available from the third parties 15 and can then make selections 20 from the compiled and filtered list of events 19. These selected events 20 are added or merged with the user's personal events 12.

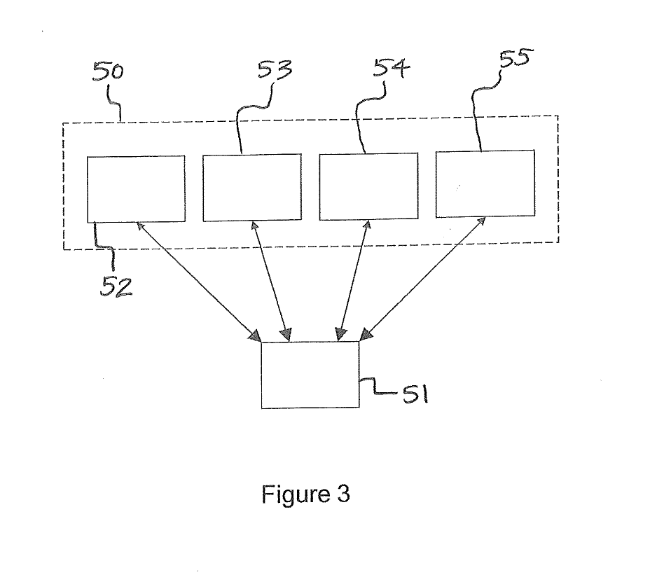

FIG. 2 discloses an example user interface for the example embodiment. The user interface 30 contains a time range indicator such as a the date 31 and a time scale 32 that allows the user to understand how events are being displayed in the context of time. In this example, the user's own personal events are displayed in a column 33 to the left of the screen. Another column 34 to the right of the screen, can be used to display events that have been supplied by third parties and compiled on the event compiling server.

The example user interface also has a filtration capability 35 that enables the user to only see events that are of particular interest to them. This filtration capability 35 may contain one or more filtration factors 36 37 which can be used to further refine what events 38 39 are displayed to the user in the third party event column 34. As the user navigates their calendar and modifies their filtration requirements 35 events are then displayed in which the user can move, select to add or drag to their personal calendar.

User Selection Functionality

User event selection functionality is included.

In one form, functionality can be affected by each event 38 39 in the filtered third party event column 34 including, in this instance, a selection box 40 that enables the user to effect the event selection functionality so as to select which event they wish to merge into their first personal event column 33. Once the user is comfortable that the selected event is going to fit within their personal schedule, then a merge capability can move the event into their personal event column 33.

In alternative forms, selection may be indicated in other ways—for example, via a swipe action.

In an alternative form, the application may “learn” user preferences over time, and thereby filter available selections on that basis.

Enhanced Filtering and Scheduling

User preferences can be linked to the user login.

In a preferred form events are available only to a user based on user ID e.g. direct email event to test@hotmail.com. so only the account holder of test@hotmail.com would see the event directly populated into the user's calendar.

In a preferred form a user's account will also automatically recognise email lists that the user subscribes to such as for example event@picnic.com so that those events will automatically populate into the user's calendar.

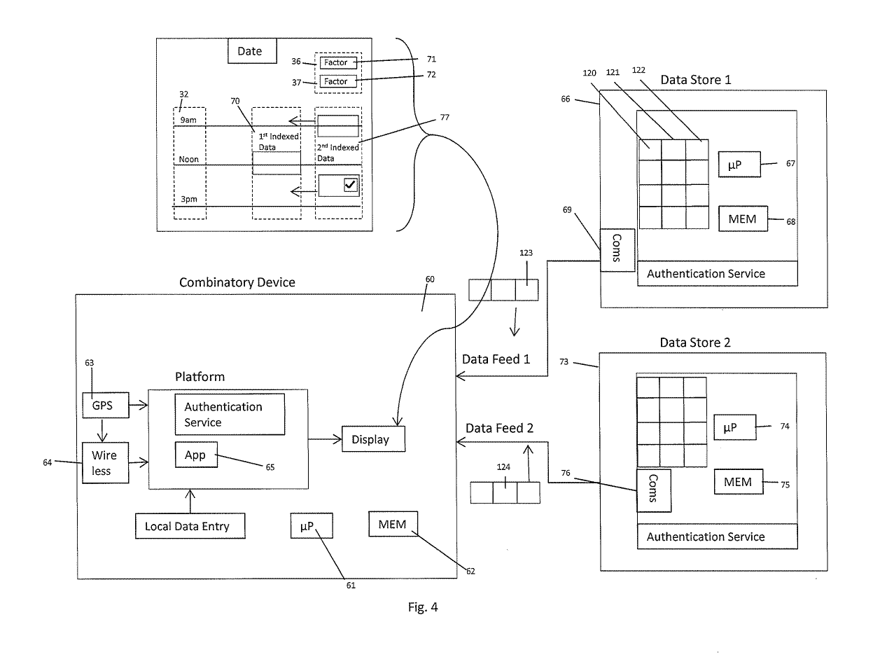

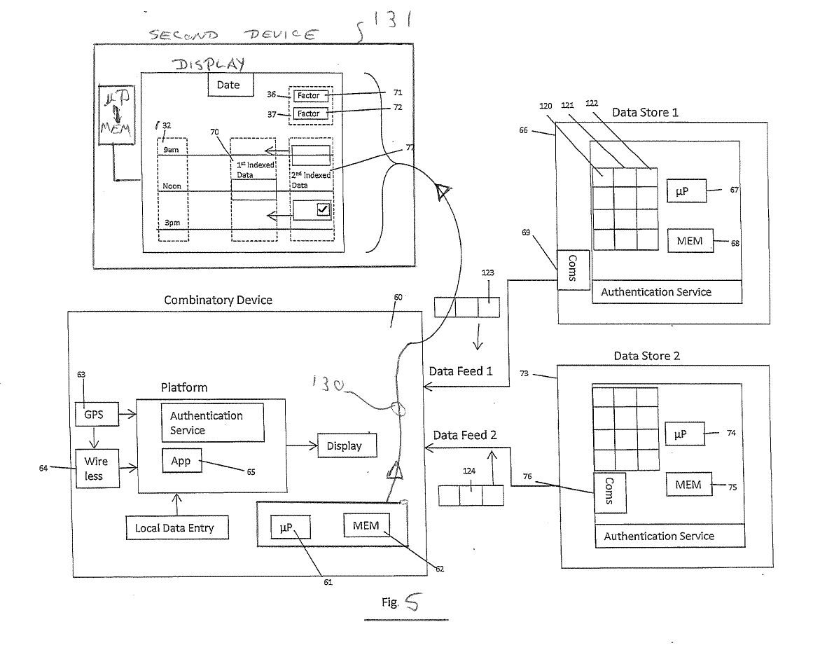

FIG. 3 discloses functionality of the way the event filtration system could work. Each event contributed by third party publishers could have a number of attributes 50 that are associated with each individual event. These attributes 50 can be used to filter what events are displayed to the user as suggestions of events to include in their personal calendar. In the example description in FIG. 3 the attributes 50 from each event can include dates and times 52 to be filtered, for example, August 1st to August 7th. Another attribute 50 of events to be filtered and displayed to the user could be events in a particular location, or region 53. Each event can also include a category definition 54. For example, events that are related to music and festivals can be searched and filtered for viewing in the filtered event suggestion list 51. Another attribute 50 could be a keyword or keywords 55 which can assist the user to find desired events to consider for including in their personal calendar. FIG. 4 is an electronic block diagram of an implementation of an embodiment of the system.

This implementation gives effect to the core idea that an event search platform combined with a personal calendar is provided whereby events populate into a time scale 32. This arrangement allows a user via a user interface to see what events are available referenced against time. As will be described below, the events may be derived from multiple, separate data feeds.

FIG. 4 illustrates a combinatory device 60; said combinatory device 60 having at least a processor 61, a memory 62, a GPS module 63 and a wireless communications module 64 all in electronic communication with each other within the combinatory device 60; a software module 65 executable on the combinatory device 60; the software module 65 receiving data from at least a first data store 66; said data store 66 having at least a first processor 67, a memory 68 and a first data store communications module 69; the first datastore 66 storing at least first indexed data 70; said first indexed data 70 referenced against at least a first criterion 71 and a second criterion 72; the software module 65 receiving data from at least a second datastore 73; said second datastore 73 having at least a processor 74, a memory 75 and a second datastore communications module 76; the second datastore 73 storing at least second indexed data 77; said second indexed data 77 referenced against at least said first criterion 71 and said second criterion 72.

Broadly, the arrangement of FIG. 4 gives effect to a method of combining content retrieved from an internet connected computer network; the method comprising of storing fixed form content and variable form content in a first database; storing fixed form content and variable form content in at least a second database remote from the first database; indexing the variable form content by the use of keys; transmitting the variable form content and the fixed form content to a combinatory device; selecting content derived from the variable form content for presentation referenced against a time scale based on criteria.

In preferred forms, content is selected from the variable form content based on the keys.

In preferred forms selection is determined with reference to previous patterns of use of a user.

In preferred forms patterns of use of a user are used to determine which criteria are used for selection of variable form content.

In use, with reference to FIG. 4, data store 1 contains data entries comprising a key 120, fixed form content 121 and variable form content 122, as does at least data store 2.

Based on selection criteria, packets 123, 124 of selected entries are transmitted via data feed 1 and data feed 2 to the combinatory device.

Export Functionality

FIG. 5 is an electronic block diagram of an implementation of a further embodiment of the system incorporating export functionality to a second digital device.

More particularly like components are numbered as for previous embodiments. In this instance the combinatory device 60 may export 130 data to a second, external device 131 for the purposes of displaying either the same data as appears on the display of the combinatory device 60 or modified data.

In preferred forms the filtration system of earlier embodiments may be applied whereby information displayed against a time base 132 may vary from that displayed on the combinatory device 60 based on criteria set by a user. In alternative forms the criteria may be determined by observation of a user's past selections in order to apply criteria automatically.

Automatic Population Functionality

In a further preferred form with reference to both FIG. 4 and FIG. 5 the display and more particularly the mapping against the timeline 132, 32 may be determined by criteria determined from observation of determinations previously made by a user.

In a particular form “fill the gaps” functionality can be provided whereby the system intelligently fills time spaces in the time base 32, 132. In preferred forms the “filling” may be done by reference to previous selections of a user.

### Alternative Embodiments

The example embodiment shows the system being capable of supplying third party event suggestions to a person, including third party events into their own personal calendar. An alternative embodiment could see the user including third party events in different scenarios, such as their business calendar and the third party could include a wide range of event publishers, including but not limited to their own company, groups of friends and including international events, such as “Worldwide Children's Day.”

The example user interface described in FIG. 2 shows a two column arrangement where the user's personal calendar is displayed in one column and the filtered event suggestions from third parties are in a second column, and the time scale is for a certain time period over the course of one day. An alternative embodiment could use any calendar related interface, including but not limited to, multi-day view, weekly view of any consecutive 7 days, monthly view or yearly view.

Another alternative embodiment could show the third party suggested events and/or product offers, received via private messaging and/or received private messaging via any messaging channels, in the same calendar system as the user's own personal diary, and displayed differently such as with a certain colour or colour range, or different symbol and/or texture to differentiate the third party events, product offers, those received via private messaging and/or received private messaging via any messaging channels, and the user's personal events within their calendar.

The example embodiment in FIG. 2 of the user interface includes a filtration system with only two filtering parameters. This is shown for simplicity sake. An alternative embodiment could use any number of filtration parameters, such as filtering events according to their friends or connections, interests and attendance, to enable a user to have events displayed to them of which they have interest in.

1. A software module for receiving a data feed from multiple sources; said software module executable on a combinatory device; said combinatory device having at least a processor, a memory, a GPS module and a wireless communications module all in electronic communication with each other within the combinatory device; the software module receiving data from at least a first data store; said data store having at least a first processor, a memory and a first data store communications module; the first datastore storing at least first indexed data; said first indexed data referenced against at least a first criterion and a second criterion;
the software module receiving data from at least a second datastore; said second datastore having at least a processor, a memory and a second datastore communications module; the second datastore storing at least second indexed data; said second indexed data referenced against at least a first criterion and a second criterion.

2. A combinatory device; said combinatory device having at least a processor, a memory, a GPS module and a wireless communications module all in electronic communication with each other within the combinatory device; a software module executable on the combinatory device; the software module receiving data from at least a first data store; said data store having at least a first processor, a memory and a first data store communications module; the first datastore storing at least first indexed data; said first indexed data referenced against at least a first criterion and a second criterion; the software module receiving data from at least a second datastore; said second datastore having at least a processor, a memory and a second datastore communications module; the second datastore storing at least second indexed data; said second indexed data referenced against at least a first criterion and a second criterion.

3. A content combining system for combining content retrieved from an Internet computer network; a local client on a combinatory device generating network access requests for individual controlled access network accounts; at least one combining scheme; the combining scheme allowing network access requests via an operating system whereby controlled access accounts may be given selected access to one or more datastores located remotely.

4. A method of combining content retrieved from an internet connected computer network; the method comprising of storing fixed form content and variable form content in a first database;
storing fixed form content and variable form content in at least a second database remote from the first database; indexing the variable form content by the use of keys; transmitting the variable form content and the fixed form content to a combinatory device; selecting content derived from the variable form content for presentation referenced against a time scale based on criteria.

5. The method of claim 4 wherein content is selected from the variable form content based on the keys.

6. The method of claim 4 wherein selection is determined with reference to previous patterns of use of a user.

7. The method of claim 4 wherein patterns of use of a user are used to determine which criteria are used for selection of variable form content.
